(19) United States
(12) Patent Application Publication
(10) Pub. No.: US 2020/0329646 A1
(43) Pub. Date: Oct. 22, 2020

(54) REFRIGERATING CULTIVATION GREENHOUSE

(71) Applicant: WUYI UNIVERSITY, Jiangmen (CN)

(72) Inventor: Min WU, Jiangmen (CN)

(21) Appl. No.: 16/519,449

(22) Filed: Jul. 23, 2019

(30) Foreign Application Priority Data
Apr. 22, 2019 (CN) 201910324184.X

(51) Int. Cl. A01G 9/24; A01G 9/16; A01G 9/14

(52) U.S. Cl. CPC A01G 9/24; A01G 9/1438; A01G 9/16

(57) ABSTRACT

A refrigerating cultivation greenhouse is disclosed, including a support pedestal where fixed parts embedded underground. A connection block is fixed on the fixed parts. A greenhouse framework fixed on the connection block. Plastic covering films structured by two layers are disposed on an outer layer and an inner layer of the framework. A refrigeration system includes a refrigerant circulation system, an air box, an air outlet pipe communicating with the air box and interior of the greenhouse, and an air inlet pipe communicating with the air box and interior of the greenhouse. The air inlet pipe may be provided with an exhaust fan. Heat exchange occurs between refrigerant and hot air within the air box. In such a way, the air is conveyed into the air box.

### FIELD

The present disclosure relates to the technical field of agriculture, and in particular, to a refrigerating cultivation greenhouse.

### INTRODUCTION

At present, it is necessarily important to maintain a relative low temperature for the growth of some crops. And concerning the greenhouse cultivation, maintaining the temperature of a greenhouse is particularly significant.

### SUMMARY

At least one problem is to be solved to some extent by some implementations of the present disclosure. To this end, a refrigerating cultivation greenhouse is disclosed.

The technical solutions adopted by the present disclosure to solve the technical problems include the following.

A refrigerating cultivation greenhouse of the present disclosure may include a support pedestal. The support pedestal includes fixed parts and connection blocks, the fixed parts being embedded underground, and the connection blocks being installed on the fixed parts. The connection blocks are disposed above the ground. A greenhouse framework is fixed on the connection blocks, the greenhouse framework being of a semicircular shape. Two layers of plastic covering films are respectively disposed on a surface and an inner side of the greenhouse framework. A refrigeration system is configured to cool air in the greenhouse framework. The refrigeration system includes a refrigerant circulation system, configured to drive circulation flow of a refrigerant to flow circularly; an air box, configured to exchange heat between the refrigerant and hot air; an air outlet pipe, disposed between the air box and the greenhouse framework, the air outlet pipe communicating with the air box and an interior of the greenhouse framework; and an air inlet pipe, disposed between the air box and the greenhouse framework, the air inlet pipe communicating with the air box and the interior of the greenhouse framework; an exhaust fan being provided in the air inlet pipe.

Beneficial effects include the following: air in the greenhouse is cooled by being conveyed continuously into the air box for cooling; then, the two layers of covering films are used to preserve heat in the greenhouse, thereby guaranteeing the cooling effect.

The refrigerant circulation system may include a compressor, which is configured to compress the refrigerant, so that the refrigerant flows in a pipeline; a condenser is configured to absorb heat of the refrigerant conveyed from the compressor, so that the gasified refrigerant becomes a liquid; an expansion valve is configured to perform throttling and depressurization to the liquid refrigerant; and an evaporator is configured to exchange heat with outside air by using the refrigerant; and the compressor, the condenser, the expansion valve and the evaporator are sequentially connected to form a loop, with the evaporator being disposed in the air box. The refrigerant enters into the evaporator to exchange heat with hot air in the air box after being processed in the compressor, the condenser, and the expansion valve, such that the hot air is cooled then conveyed back to the greenhouse.

In some examples, the air inlet pipe is disposed on an upper end of the air box, the air outlet pipe is disposed on a lower end of the air box. A spiral pipeline is disposed in the air box, and two ends of the spiral pipeline respectively communicate with the air outlet pipe and the air inlet pipe; such that an area for heat exchange between the hot air and the refrigerant is increased, therefore improving the heat exchange efficiency.

Further, a shutter machine may be disposed on the greenhouse framework. For example, a shutter machine may be located at the center of the greenhouse framework and capable of stretching curtain cloth to two sides of the framework. A surface of the curtain cloth of the shutter machine is covered by a heat reflection coating. The shutter machine is used to control sunshine duration and the heat reflection coating effectively reflects the heat of sunlight, so that the cooling effect is guaranteed.

Further, the shutter machine may be disposed as being sandwiched between the two layers of plastic covering films, such that the curtain cloth of the shutter machine can stretch smoothly along a channel formed by the two layers of plastic covering films.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

The present disclosure will be further illustrated with the accompanying drawings and embodiments below.

FIG. 1 is a schematic structural diagram of the present disclosure; and

FIG. 2 is a schematic structural diagram of a refrigeration system of the present disclosure.

### DETAILED DESCRIPTION

Various aspects and examples of a refrigerating cultivation greenhouse, as well as related methods, are described below and illustrated in the associated drawings. Unless otherwise specified, a refrigerating cultivation greenhouse in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

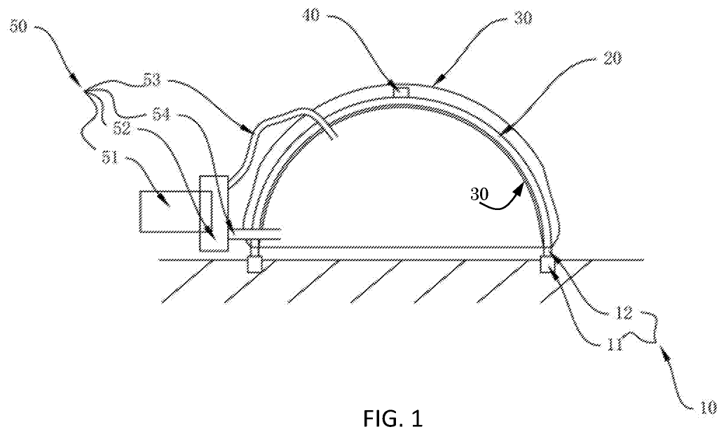

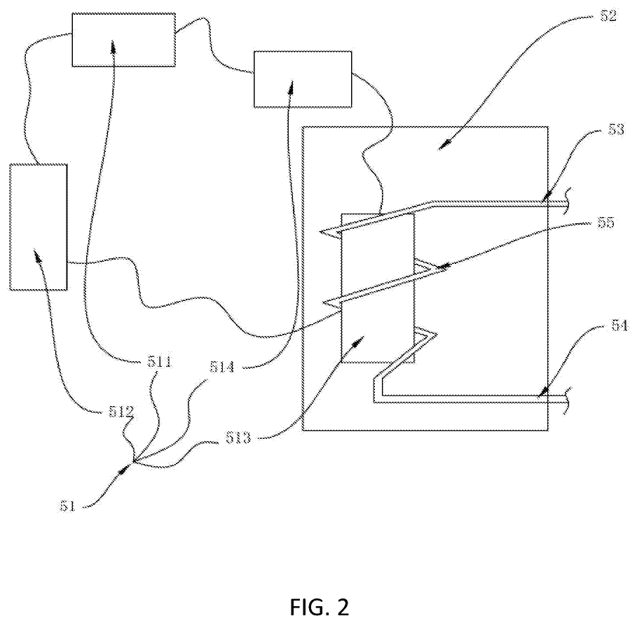

Referring to FIG. 1 and FIG. 2, a refrigerating cultivation greenhouse provided by the present disclosure includes a support pedestal 10, the support pedestal 10 includes fixed parts 11 and connection blocks 12. The fixed parts 11 are embedded underground, the connection blocks 12 are installed on the fixed parts 11, and the connection blocks 12 are disposed above the ground. The greenhouse framework 20 is fixed on the connection blocks 12, the greenhouse framework 20 being of a semicircular shape. Plastic covering films 30, being structured by two layers of plastic covering films 30, are respectively disposed on an outer surface and an inner side of the greenhouse framework 20.

The refrigeration system 50 includes a refrigerant circulation system 51, configured to drive a refrigerant to flow circularly; an air box 52, configured to exchange heat between the refrigerant and hot air; an air outlet pipe 54, disposed between the air box 52 and the greenhouse framework 20, the air outlet pipe 54 communicating with the air box 52 and an interior of the greenhouse framework 20; and an air inlet pipe 53, disposed between the air box 52 and the greenhouse framework 20, the air inlet pipe 53 communicating with the air box 52 and the interior of the greenhouse framework 20, and an exhaust fan being provided in the air inlet pipe 53.

In actual use, air in the greenhouse is continuously conveyed into the air box 52 for cooling, via the exhaust fan. Then, the two layer of covering films 30 are used to preserve the temperature in the greenhouse, thereby guaranteeing the cooling effect.

In some embodiments, the refrigerant circulation system 51 includes a compressor 512, which is configured to compress the refrigerant, so that the refrigerant flows in a pipeline; a condenser 511, which is configured to absorb heat of the refrigerant conveyed from the compressor 512, so that the gasified refrigerant becomes a liquid; an expansion valve 514, which is configured to perform throttling and depressurization to the liquid refrigerant; and an evaporator 513, which is configured to exchange heat with outside air by using the refrigerant; and the compressor 512, the condenser 511, the expansion valve 514 and the evaporator 513 are sequentially connected to form a loop, with the evaporator 513 being disposed in the air box 52.

The refrigerant enters into the evaporator 513 after being processed in the compressor 512, the condenser 511, and the expansion valve 514. Heat exchange occurs between the refrigerant in the evaporator 513 and hot air in the air box 52, such that the hot air is cooled then conveyed back to the greenhouse again via the air outlet pipe 54.

In some embodiments, the air inlet pipe 53 is disposed on an upper end of the air box 52, the air outlet pipe 54 is disposed on a lower end of the air box 52, a spiral pipeline 55 is disposed in the air box 52, and two ends of the spiral pipeline 55 respectively communicate with the air outlet pipe 54 and the air inlet pipe 53, such that an area for heat exchange between the hot air and the refrigerant is increased, therefore improving the heat exchange efficiency. The hot air and cold air are layered in a position that the cold air is located as a lower layer and re-enters into the greenhouse via the air outlet pipe 54 as cold air supplement.

In some embodiments, a shutter machine 40 is disposed on the greenhouse framework 20. The shutter machine 40 is located at the center of the greenhouse framework 20, and is capable of stretching curtain cloth to two sides of the framework 20. A surface of the curtain cloth of the shutter machine 40 is covered by a heat reflection coating. The shutter machine 40 is used to control sunshine duration and the heat reflection coating effectively reflects the heat of sunlight, such that the cooling effect is guaranteed.

In some embodiments, the shutter machine 40 is disposed between two layers of plastic covering films 30, such that curtain cloth of the shutter machine 40 can stretch smoothly along a channel formed by the two layers of plastic covering films 30.

The above specific structures and dimensional data are specific descriptions on preferred embodiments of the present disclosure. However, the present disclosure is not limited to the above embodiments. Those skilled in the art may further make various equivalent variations or replacements without departing from the spirit of the present disclosure, and these equivalent variations or replacements are all included in the scope defined by the claims of the present application.

What is claimed is:

1. A refrigerating cultivation greenhouse, comprising:
a support pedestal, comprising fixed parts and connection blocks, the fixed parts being embedded underground, the connection blocks being installed on the fixed parts, and the connection blocks being disposed aboveground;
a greenhouse framework fixed on the connection blocks, the greenhouse framework having a semicircular shape;
two layers of plastic covering films respectively disposed on an outer surface and an inner side of the greenhouse framework; and
a refrigeration system, configured to cool air in the greenhouse framework, wherein the refrigeration system includes:
a refrigerant circulation system configured to drive circulation flow of a refrigerant;
an air box, configured to exchange heat between the refrigerant and outside air;
an air outlet pipe, disposed between the air box and the greenhouse framework, the air outlet pipe communicating with the air box and an interior of the greenhouse framework;
an air inlet pipe, disposed between the air box and the greenhouse framework, the air inlet pipe communicating with the air box and the interior of the greenhouse framework; and
an exhaust fan provided in the air inlet pipe.

2. The refrigerating cultivation greenhouse according to claim 1, wherein the refrigerant circulation system further comprises:
a compressor, configured to compress the refrigerant, so that the refrigerant flows in a pipeline;
a condenser, configured to absorb heat of the refrigerant conveyed from the compressor, so that the refrigerant becomes a liquid;
an expansion valve, configured to perform throttling and depressurization of the liquid refrigerant;
and an evaporator, configured to exchange heat with outside air using the refrigerant;
wherein the compressor, the condenser, the expansion valve, and the evaporator are sequentially connected to form a loop, with the evaporator being disposed in the air box.

3. The refrigerating cultivation greenhouse according to claim 2, wherein the air inlet pipe is disposed on an upper end of the air box and the air outlet pipe is disposed on a lower end of the air box; further comprising a spiral pipeline disposed in the air box, each of two ends of the spiral pipeline respectively communicating with the air outlet pipe or the air inlet pipe.

4. The refrigerating cultivation greenhouse according to claim 1, wherein a shutter machine is disposed on the greenhouse framework, the shutter machine being located at the center of the greenhouse framework and configured to stretch curtain cloth to two sides of the framework, wherein a surface of the curtain cloth of the shutter machine is covered by a heat-reflective coating.

5. The refrigerating cultivation greenhouse according to claim 4, wherein the shutter machine is disposed between the two layers of plastic covering films.
